(19) United States
(12) Patent Application Publication
(10) Pub. No.: US 2010/0147626 A1
(43) Pub. Date: Jun. 17, 2010

(54) Passenger cage for elevators

(76) Inventor: Andreas Jebing, Kurten (DE)

Correspondence Address: RANKIN, HILL & CLARK LLP, 23755 LORAIN ROAD, SUITE 200, NORTH OLMSTED, OH, 44070, US

(21) Appl. No.: 12/226,558

(22) PCT Filed: May 2, 2007
(86) PCT No.: PCT/EP2007/003854

§ 371 Date: Oct. 21, 2008

(30) Foreign Application Priority Data
May 16, 2006 (DE) 20 2006 007 836.3

(51) Int. Cl. B66B 13/30; E04G 5/00

(52) U.S. Cl. 182/141

(57) ABSTRACT

The invention relates to a lift cage, in particular a lift cage for persons, for navigating towers, cranes, wind energy plants, pillars of wind energy plants or the like, with a floor 4, with a plurality of side walls 11 rigidly connected thereto and with a lateral opening 12 which can be closed by means of a door 20 between two opposing side walls 11, the door 20 having two door wings 21 which are displaceable parallel to each other. In order to allow secure locking of the door and convenient entry, according to the invention one door wing 21 is displaceably supported by the other door wing by means of a plurality of longitudinal pullouts and guided by means of first guide means in guides 15 parallel to the lateral opening 12 and by means of second guide means in guides 16 parallel to one of the side walls 11.

This application claims priority from International Application PCT/EP2007/003854 filed on May 2, 2007 which is hereby incorporated by reference herein in its entirety and which forms a part of the specification of this application which claims priority in German Application Serial No. 20 2006 007 836.3 filed on May 16, 2006 and which is hereby incorporated by reference herein in its entirety and which forms a part of the specification of this application.

The invention relates to a lift cage for lifting devices, in particular a lift cage for persons, for navigating towers, cranes, masts, wind energy plants or the like, with a floor, with a plurality of side walls rigidly connected to the floor and with a lateral opening which can be closed by means of a door between two opposing side walls, the door having a first and a second door wing which are displaceable parallel to each other.

In order in multistory buildings, cranes, high towers and other installations to convey equipment and persons vertically over high heights, use is often made of what are known as lift cages or cages for persons that can be moved vertically as lifting devices by means of suitable cable winches. In contrast to elevators which are usually fixedly mounted in buildings in elevator shafts and which are designed to be relatively spacious for the simultaneous transportation of a plurality of persons, there is in lift cages and lift cages for persons a significant space problem, so that such lift cages can usually convey only one to two persons. At the same time, as the lift cage for persons can also be used at high heights, it must be ensured, to allow the transportation of persons, that the inlet opening can be securely closed with a suitable door or door device. If a lift cage is moved in a closed shaft, the door can be relatively simple in its construction. In the case of free-moving lift cages, on the other hand, the door must be designed to be able, if appropriate, to withstand also the forces of a person leaning against the door.

The Applicant has for some time sold a lift cage with a door having a plurality of door wings, one of which is fixedly mounted and thus covers half or one third of the maximum available lateral opening, in which case only the further door wings are extended for closing the door and locked to the side wall opposing the stationary door wing. A drawback of this is that this lift cage has to be relatively wide in its construction to allow the persons to be transported convenient access to the lift cage.

### SUMMARY OF INVENTION

The invention relates to a lift cage for lifting devices, in particular to a lift cage for persons, for navigating towers, cranes, wind energy plants, pillars of wind energy plants or the like, with a floor, a plurality of side walls rigidly connected to the floor and with a lateral opening which can be closed by way of a door between two opposing side walls, the door having a first door wing and a second door wing which are displaceable parallel to each other wherein the first door wing displaceably supports the second door wing by way of a plurality of longitudinal pullouts and in that the first door wing is movably guided by a first guide device in first guide elements parallel to the lateral opening and by a second guide device in second guide elements parallel to one of the side walls adjoining the lateral opening.

An object of the invention is to provide a lift cage, in particular a lift cage for persons, which does not have the aforementioned drawbacks and which allows convenient entry or convenient loading while at the same time securely sealing off the lateral opening with the door.

According to an aspect of the invention, this object is achieved in that the first door wing displaceably supports the second door wing by means of a plurality of longitudinal pullouts and in that the first door wing is movably guided by means of first guide means in first guide elements parallel to the lateral opening and by means of second guide means in second guide elements parallel to one of the side walls adjoining the lateral opening. Therefore, in the case of the lift cage according to the invention, not only is the second door wing moved relative to the first door wing in order to increase the size of the lateral opening, and thus of the access opening to the lift cage, but rather the first door wing is also at the same time moved together with the second door wing to increase the size of the access opening.

According to another aspect of the invention, the first and second guide means allow the first door wing to swivel relative to the associated guide elements. As a result of the combined parallel telescoping of the guide elements, on the one hand, and preferably subsequent swiveling of the telescoped pack consisting of the first and second door wings, it is possible to achieve in the open position of the door an end position in which the door is with both door wings positioned parallel or substantially parallel to one of the side walls. As prior to swiveling the two door wings are first telescoped, the swiveling movement can in this case be caused over a relatively small swivel radius, so that even in the case of small lift cages a person can easily stand in the lift cage, while the door is opened or closed by the combined telescoping and swiveling. A particularly space-saving and at the same time stable configuration can be achieved if the second door wing can be sunk into the first door wing.

According to an advantageous configuration according to another aspect of the invention, the first guide means can comprise on the underside of the first door wing a guide pin which engages with a guide track formed in the floor. Corresponding guide pins could of course also be configured on the upper side of the first door wing. It is nevertheless preferred if the first guide means also comprise on the upper side of the first door wing a guide roller which is guided in a guide rail overlapping the lateral opening. Furthermore, preferably, the second guide means can also comprise on the upper side of the first door wing a guide roller which is guided in a guide rail arranged parallel to the side wall. The provision of guide rollers on the upper side of the first door wing allows a partial weight of the door as a whole to be supported on corresponding guide rails, so that in particular the guide elements for the first door wing in the floor are substantially relieved of the weight forces and can serve predominantly to stabilize the door in the closed position and during the opening and closing movement. The second guide means on the underside of the first door wing can therefore also consist of a guide pin which engages with a groove or grooved rail, accordingly oriented or extending parallel to the side wall, in the floor of the lift cage. For beneficial support and movement guidance, it is advantageous if the first guide means are arranged close to or directly on the leading end face of the first door wing and the second guide means are arranged set apart from the first guide means close to or directly on the trailing end face of the first door wing in order to achieve in the closed position a door position which is orthogonal relative to the adjacent side walls. As the lift cage-side guide elements for the second guide means extend perpendicularly to the guide elements for the first guide means, it is particularly advantageous if the guide rollers are pivotably fastened to the first door wing in order to assist with the guide rollers the swiveling of the door wing during the opening or closing movement while at the same time guiding and supporting the door. If rollers are used as guide means, it is particularly advantageous if the guide elements consist of profile rails, in particular of C-shaped profile rails, in which the rollers are guided, in which case the rollers can in particular consist of double rollers.

In order to configure the two door wings so as to be displaceable relative to each other with high stability, it is furthermore advantageous if at least two of the longitudinal pullouts accommodate orthogonally to one another the forces between the first and second door wings. A total of at least or exactly three longitudinal pullouts can be provided for this purpose, two longitudinal pullouts supporting the second door wing in respect of the forces in the horizontal direction and one longitudinal pullout supporting the second door wing in respect of the forces in the vertical direction on the first door wing. Expediently, the longitudinal pullouts for the forces in the horizontal direction are arranged between the upper sides and undersides of the first and second door wings and the longitudinal pullout for the forces in the vertical direction is arranged between the door leaves of the door wings.

In order not unnecessarily to increase the total weight of a lift cage, the side walls and/or the door wings can be formed of rigidified grating elements or grating constructions. Furthermore, it is advantageous if a cable winch and/or an arrester device are mounted below the floor of the lift cage, cable guides preferably being attached to the back of the cage in order to guide the traction and arrester cable, which allow the lift cage to be moved over the height, securely outside the passenger compartment of the lift cage for persons. In order to achieve secure locking of the door in the closed position, the second door wing can have a closure element which can be detachably locked in a closure device fastened to the opposing side wall.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is a perspective view of a lift cage for persons according to the invention with a partly opened door;

FIG. 2 is a detailed, partly exploded view of the door, looking onto the front of the door; and

FIG. 3 is a plan view onto the door from FIG. 2 with differing positions of the two door wings.

### DETAILED DESCRIPTION OF THE INVENTION

Referring now to the drawings wherein the showings are for the purpose of illustrating preferred and alternative embodiments of the invention only and not for the purpose of limiting same,

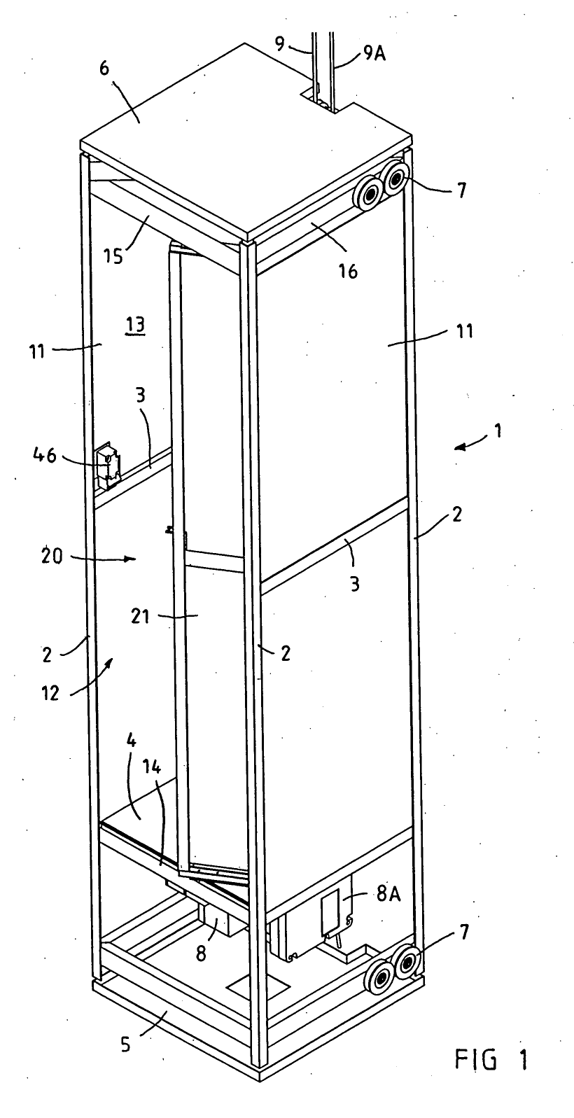

In FIG. 1, reference numeral 1 denotes a lift cage for persons according to the invention illustrated in a highly schematically simplified manner. The lift cage for persons comprises a flexurally rigid, self-supporting frame formed substantially by means of four vertical struts 2 in the four corners, a large number of intermediate struts 3, a floor 4, a sub-floor 5 and an upper cover 6. A large number of further struts can extend between the vertical struts 2 to strengthen the frame construction. Rollers 7 can be rotatably mounted on some of these struts in order to be able to transport the lift cage 1 in a simplified manner using a vehicle or, if appropriate, also to be able to move it horizontally by means of cables. Formed between the floor 4 and the sub-floor 5 is a drive box in which a cable winch 8 as well as an arrester device 8A are mounted in order to be able vertically to move the lift cage 1 for persons by means of traction cables 9, 9A.

Mounted between each two vertical struts 2 are, on three sides of the lift cage 1 that are at right angles to one another, side walls 11 which if appropriate consist of a plurality of elements, in particular grating elements or the like, the two opposing side walls 11 shown delimiting together with the associated vertical struts 2 a lateral opening 12 through which the persons can enter a passenger compartment 13 in the lift cage or can load equipment or tools therein in order to move the persons or the equipment over high heights.

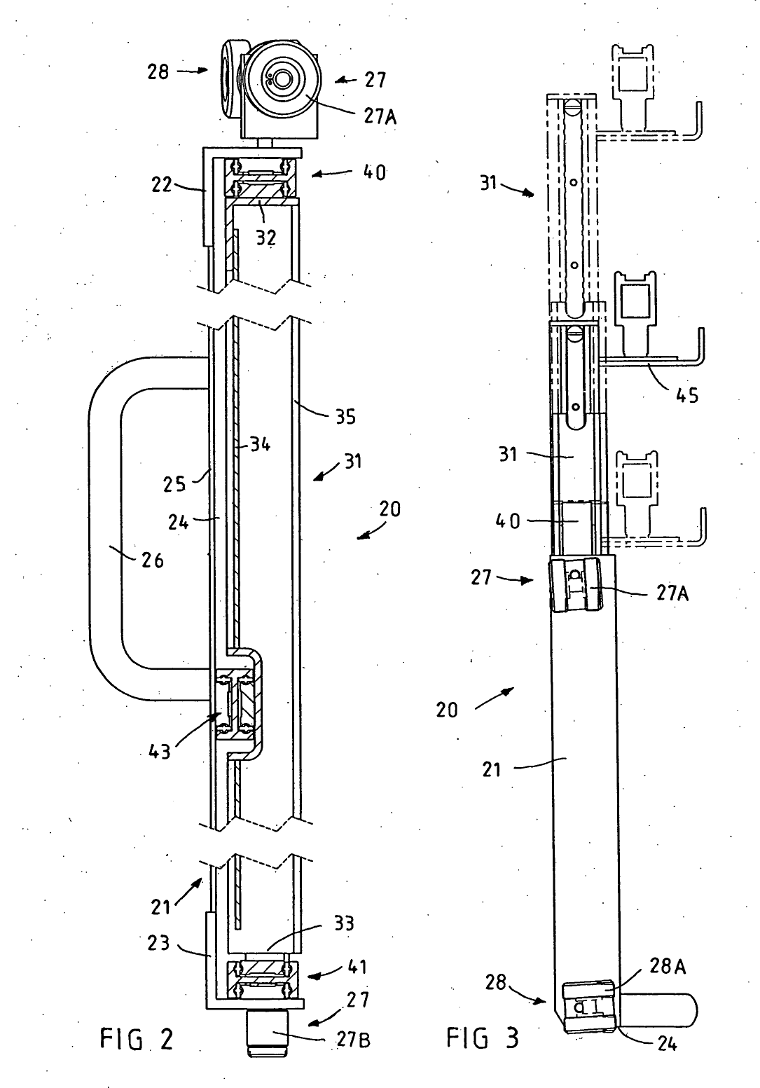

The lift cage 1 is in particular designed to move persons in tower, mast or column constructions of wind energy plants in which working platforms form inside the column a plurality of stories which are provided with recesses through which the lift cage 1 can be drawn in order to convey persons up to a rotor which is mounted at the upper end of the column and carries the rotor blades of the wind energy plant. As in these towers no shaft can be provided for the lift cage 1, the lateral opening 12 can be closed and sealed off by means of a door 20, the construction of which will now be described with additional reference to FIGS. 2 and 3.

The door 20 for a lift cage 1 according to the invention comprises a first, outer, inherently stable door wing 21 having upper and lower door edge profiles 22, 23, a backward, vertically towering door edge strut 24 and also a door wing 25 which towers therebetween and preferably consists of a single sheet-metal grating or a plurality of sheet-metal gratings on which there is also arranged inter alia a handle 26 via which the person can cause the opening and closing movement of the door 20. A second, again inherently stable door wing 31 having upper and lower door edge profiles 32, 33, and also in this case front and rear door leaves 34, 35, is arranged in the hollow interior of the first door wing 21 so as to be displaceable parallel to the first door wing 21. The second door wing 31 can be sunk into the cavity or interior of the first door wing 21, wherein there is arranged for the longitudinal displacement of the door wings relative to each other between the upper profile edges 22, 32 a first, extendable longitudinal pullout 40 and between the lower door profile edges 23, 33 a second longitudinal pullout 41 with which the two parallel door wings 21, 31 run parallel to each other and which can be used to support forces of the type acting in the horizontal direction between the two door wings 21, 31. Additionally arranged between the door leaf 25 of the first door wing 21 and the door leaf 34 of the second door wing 31 is a third longitudinal pullout 43 which, again, has rails or the like which are displaceable relative to one another but arranged orthogonally to those of the first and second longitudinal pullouts 40, 41. With the longitudinal pullout 43, it is possible to support between the door wings 21, 31 forces acting in the vertical direction especially when the second door wing 31 is fully extended from the interior of the first door wing 31, such as is indicated by dot-dash lines in FIG. 3. The longitudinal pullouts 40, 41 for supporting the forces in the horizontal direction and the longitudinal pullout 43 for supporting the forces in the vertical direction can have a large number of different configurations, wherein in particular the longitudinal pullout 43 could also be arranged at different levels and also eccentrically between the door leaves 25, 34.

According to the invention, there are arranged on the first door wing 21 a plurality of guide means with which the first door wing 21 can be displaced relative to the lateral opening 12 of the lift cage 1, substantially independently of the extended state or telescoped state of the second door wing 31, in such a way that when the door 20 is in the open position said door is located parallel to one of the two side walls 11. In this open position (not shown), the inlet opening 12 is then almost completely free, without any parts or elements of the door 20 projecting laterally beyond the outer dimensions of the lift cage 1 or significantly reducing the clear width of the door opening 12.

In the illustrated exemplary embodiment, mutually set-apart front, first guide means 27 and rear, second guide means 28 are associated with the first door wing 21. The guide means 27, 28 are preferably provided in pairs, a first guide means being associated with the upper door edge profile 22 and a second guide means 27 being associated with the lower door edge profile 23 of the first door wing. In the exemplary embodiment shown, three of the guide means 27, 28, of which there are in total preferably four, are illustrated. The front, first guide means 27, which is associated with the upper door edge profile 22 or the upper side of the first door wing 21, preferably consists of a roller or double roller 27A arranged near the open front, allowing extension of the second door wing 31 from the first door wing 21. The front, first guide means, which is associated with the lower door edge profile, is preferably formed by a guide pin 27B which is fastened below the lower door edge profile 23 or below the underside of the first door wing 21. Close to or preferably flush with the back edge 24 of the first door wing 21, a second roller or double roller 28A is also pivotably mounted on the upper door edge profile 22 as the second guide means 28, whereas a second guide pin (not shown) is preferably arranged on the same axis thereto on the lower door edge profile 23. The front guide pin 27A of the first door wing 21 is guided in a grooved guide 14 which is formed in or introduced into the floor 4 of the lift cage 1 parallel to the lateral opening 12. The rear guide pin is guided accordingly in a second grooved guide in the floor 4 that is formed in the floor 4 parallel to the side wall 11 facing the viewer in FIG. 1. The front, upper guide roller 27A of the first door wing 21 dips from below into a guide rail 15 which has a preferably C-shaped profile and overlaps the lateral opening 12 transversely between the two opposing side walls 11 and the rear guide roller 28A is guided in an identical manner in a guide rail 16 which has a C-shaped profile, is arranged at the same level as the guide rail 15 and extends between the two vertical struts 2 parallel to, although further inward than, the side wall 11. The first door wing 21 is accordingly guided with front guide means 27 in guides 14, 15 parallel to the lateral opening 12 and with rear guide means 28 parallel to the side wall 11. The two guide rollers 27A, 28A on the upper side of the door wing 21 are pivotably mounted, so that the door wing 21 can assume during the opening or closing movement any intermediate position between a first position approximately parallel to the inlet opening 12 and a second position approximately parallel to the side wall 11.

As the first door wing 21, which is guided upward and downward at its two ends, is relatively short, a comparatively narrow swivel angle is achieved for the door wing 21 and thus for the door 20 as a whole, as during the swiveling movement the second door wing 31 is preferably telescoped into the first door wing 21. Opening and closing the door wing 20 from a closed position, in which the front lateral opening 12 is completely closed, into an open position, in which the front lateral opening 12 is almost completely opened between both vertical struts 2, can therefore be carried out without difficulty even by a person standing in the passenger compartment 13 of the lift cage 1. At the same time, the first door wing 21 is stably guided on the frame owing to the guide means 27, 28 which are formed both on the upper side and on the underside of said first door wing and engage with corresponding guide elements 14 or 15, 16 parallel to the lateral opening or parallel to the side wall 11, so that said first door wing can securely accommodate all the compressive forces which might be exerted by a person leaning against the door wing 21. The longitudinal pullouts 40, 41, 43, of which there are in total three, at the same time ensure that the second door wing 31 is also securely supported on the first door wing 21 and thus overall on the frame.

In order to be able to lock the door 20 in the closed position, there is moved in conjunction with the second door wing 31 a suitable closure element 45 which locks, in the closed position of the door 20, into a closure device 46 mounted on the opposing side wall 11 and thus allows additional supporting of the second door wing 31 relative to the lateral opening 12. The closure element is preferably securely mounted on the second door wing 31.

The foregoing description will suggest to a person skilled in the art a large number of modifications which should fall under the scope of protection of the appended claims. It will be understood that instead of two door wings, a plurality of door wings could also be provided, although two door wings form the preferred configuration. The guide means and guide elements could also consist of other constructional elements. Also with regard to the longitudinal pullouts and the number of longitudinal pullouts, a large number of variations are possible, and one or two further longitudinal pullouts could for example also be provided for supporting the vertical forces. Finally, the frame construction of the lift cage can also have a large number of different configurations. In this case too, a door having the described construction could be mounted in order to expose in the open position approximately the entire lateral opening. Furthermore, the guide elements for the door wing could be arranged relative to the side walls or the front of the lift cage in such a way that the closed and/or open position is located not exactly parallel, but rather merely approximately parallel to the side wall or lateral opening.

Further, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. These combinations include, but are not limited to, combining a tank with an inner vessel arrangement. Accordingly, it is to be distinctly understood that the foregoing descriptive matter is to be interpreted merely as illustrative of the invention and not as a limitation.

1.-15. (canceled)

16. A lift cage for lifting devices, in particular a lift cage for persons, for navigating towers, cranes, wind energy plants, pillars of wind energy plants or the like, said lift cage comprising a floor with a plurality of side walls rigidly connected to said floor, said cage further including a lateral opening which can be closed by a door, said door having a first door wing and a second door wing which are displaceable parallel to each other, said first door wing displaceably supporting said second door wing by a plurality of longitudinal pullouts and in that said first door wing is movably guided by means of first guide means in a first guide element parallel to said lateral opening and by means of a second guide means in a second guide element parallel to one of said side walls adjoining said lateral opening.

17. The lift cage as claimed in claim 16, wherein said first and second guide means allow said first door wing to swivel relative to said guide elements.

18. The lift cage as claimed in claim 16, wherein said door moves between an opened and a closed position, said door being substantially parallel to said one side wall when in said opened position.

19. The lift cage as claimed in claim 18, wherein said first and second door wings are substantially parallel to said one side wall when in said opened position.

20. The lift cage as claimed in claim 16, wherein said second door wing is counter-sunk into the first door wing.

21. The lift cage as claimed in claim 20, wherein said first door has a generally C-shaped cross-sectional configuration and said second door wing fits within said C-shape of said first door wing.

22. The lift cage as claimed in claim 16, wherein said first guide means includes a guide pin on the underside of said first door wing and said first guide pin which engages a guide track formed in the floor.

23. The lift cage as claimed in claim 22, wherein said first guide means is near a front edge of said door.

24. The lift cage as claimed in claim 22, wherein said first guide means further includes a guide roller, said guide roller being positioned on an upper side of said first door wing and being guided in a guide rail overlapping said lateral opening.

25. The lift cage as claimed in claim 16, wherein said second guide means includes a guide roller on an upper side of said first door wing, said roller being guided in a guide rail arranged parallel to said one side wall.

26. The lift cage as claimed in claim 24, wherein said guide roller is a first guide roller and said guide rail is a first guide rail, said second guide means including a second guide roller on an upper side of said first door wing, said roller being guided in a second guide rail arranged parallel to said one side wall.

27. The lift cage as claimed in claim 26, wherein in said first and second guide rollers are pivotably fastened to said first door wing.

28. The lift cage as claimed in claim 26, wherein said first and second guide rails include C-shaped profile rails.

29. The lift cage as claimed in claim 16, wherein said plurality of longitudinal pullouts includes a first group of pullouts and a second group of pullouts, said first group supporting said second wing relative to said first wing in a horizontal direction and said second group supporting said second wing relative to said first wing in a vertical direction.

30. The lift cage as claimed in claim 29, wherein said first group of pullouts is two pullouts and said second group of pullouts is a single pullout.

31. The lift cage as claimed in claim 29, wherein said first wing includes a first vertically extending leaf and said second wing includes a second vertically extending leaf, said first group of pullouts being arranged between the upper sides and undersides of said door wings and said second group of pullouts being arranged between said first and second door leaves.

32. The lift cage as claimed in claim 16, wherein at least one of said side walls and said door wings includes rigidified grating elements.

33. The lift cage as claimed in claims 16, further including at least one of a cable winch and an arrester device mounted below said floor, said cage further including a cable guide mounted on a surface back of said cage.

34. The lift cage as claimed in claim 16, wherein said second door wing includes a closure element which can be detachably locked in a closure device fastened to a side wall opposite to said one side wall.

35. A lift cage for lifting devices, in particular a lift cage for persons, for navigating towers, cranes, wind energy plants, pillars of wind energy plants or the like, said lift cage comprising a floor with a plurality of vertically extending side walls rigidly connected to said floor, said cage further including a lateral opening and a door configured to selectively close said lateral opening when in a closed position, said door including a first door wing having a front edge and a back edge, a second door wing and a plurality of longitudinal pullouts joining said second door wing to said first door wing such that said second door wing is displaceable parallel to said first door wing and said first door wing supports said second door wing, said first door wing further including a first guide near said front edge and a second guide near said back edge, said first guide being guided by a first guide element parallel to said lateral opening and said second guide being guided by a second guide element parallel to one of said side walls adjoining said lateral opening as said door moves to and from said closed position.
